(19) United States
(12) Patent Application Publication
(10) Pub. No.: US 2022/0065651 A1
(43) Pub. Date: Mar. 3, 2022

(54) METHOD, APPARATUS, AND SYSTEM FOR GENERATING VIRTUAL MARKERS FOR JOURNEY ACTIVITIES

(71) Applicant: HERE Global B.V., Eindhoven (NL)

(72) Inventors: Jerome BEAUREPAIRE, Berlin (DE); Jens UNGER, Berlin (DE)

(21) Appl. No.: 17/114,145

(22) Filed: Dec. 7, 2020

Related U.S. Application Data
(60) Provisional application No. 63/071,891, filed on Aug. 28, 2020.

(51) Int. Cl. G01C 21/36; G06T 19/00; G06T 19/20; G01C 21/34

(52) U.S. Cl. CPC G01C 21/3638; G06T 19/006; G01C 21/3661; G01C 21/3423; G01C 21/3484; G06T 19/20

(57) ABSTRACT

An approach is provided for providing tailored multi-modal navigation assistance via virtual markers that transition between virtual reality (VR) and augmented reality (AR). The approach involves, for example, computing a VR world including a representation of a geographic location. The approach also involves generating one or more virtual markers in the VR world for familiarizing with the representation of the geographic location. The one or more virtual markers are further presented in an AR user interface based on detecting a physical journey to the geographic location.

### RELATED APPLICATION

This application claims priority from U.S. Provisional Application Ser. No. 63/071,891, entitled “METHOD, APPARATUS, AND SYSTEM FOR generating virtual markers FOR JOURNEY ACTIVITIES,” filed on Aug. 28, 2020, the contents of which are hereby incorporated herein in their entirety by this reference.

### BACKGROUND

Location-based service providers (e.g., mapping and navigation service providers) are continually challenged to provide compelling services and applications. One area of development relates to providing navigation guidance and/or other mapping-related information when taking journeys in new or unfamiliar areas. The problem of how to assist users when taking such journeys is especially acute for multi-modal journeys that involve potentially unfamiliar journey activities such as transitioning between different modes of transport at unfamiliar locations. Accordingly, service providers face significant technical challenges with respect to providing user-tailored multi-modal navigation assistance for unfamiliar journey activities.

### SOME EXAMPLE EMBODIMENTS

Therefore, there is a need for an approach for providing tailored multi-modal navigation assistance via virtual markers using emerging technologies such as virtual reality (VR) and augmented reality (AR) (e.g., for presenting navigation cues or other equivalent data) to merge virtual experiences related to an unfamiliar journey or journey activity (e.g., changing between different modes of transport) with actual experiences when physically taking an unfamiliar journey or performing an unfamiliar journey activity.

According to one embodiment, a method comprises computing a virtual reality world including a representation of a geographic location (e.g., a geographic location associated with an unfamiliar journey or journey activity). The method also comprises generating one or more virtual markers in the virtual reality world for familiarizing with the representation of the geographic location. The one or more virtual markers are further presented in an augmented reality user interface based on detecting a physical journey to the geographic location.

According to another embodiment, an apparatus comprises at least one processor, and at least one memory including computer program code for one or more computer programs, the at least one memory and the computer program code configured to, with the at least one processor, cause, at least in part, the apparatus to compute a virtual reality world including a representation of a geographic location (e.g., a geographic location associated with an unfamiliar journey or journey activity). The apparatus is also caused to generate one or more virtual markers in the virtual reality world for familiarizing with the representation of the geographic location. The one or more virtual markers are further presented in an augmented reality user interface based on detecting a physical journey to the geographic location.

According to another embodiment, a non-transitory computer-readable storage medium carries one or more sequences of one or more instructions which, when executed by one or more processors, cause, at least in part, an apparatus to compute a virtual reality world including a representation of a geographic location (e.g., a geographic location associated with an unfamiliar journey or journey activity). The apparatus is also caused to generate one or more virtual markers in the virtual reality world for familiarizing with the representation of the geographic location. The one or more virtual markers are further presented in an augmented reality user interface based on detecting a physical journey to the geographic location.

According to another embodiment, an apparatus comprises means for computing a virtual reality world including a representation of a geographic location (e.g., a geographic location associated with an unfamiliar journey or journey activity). The apparatus also comprises means for generating one or more virtual markers in the virtual reality world for familiarizing with the representation of the geographic location. The one or more virtual markers are further presented in an augmented reality user interface based on detecting a physical journey to the geographic location.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of generating virtual markers for journey activities, according to an example embodiment(s);

FIG. 2 is a flowchart of a process for generating virtual markers for journey activities, according to an example embodiment(s);

FIG. 3A is a diagram of a user transitioning between virtual reality (VR) and augmented reality (AR) environments using virtual markers, according to an example embodiment(s);

FIG. 3B is a diagram of user equipment supporting AR projections based on virtual markers, according to an example embodiment(s);

FIG. 4 is a diagram of the components of a journey platform capable of generating virtual markers for journey activities, according to example embodiment(s);

FIG. 5 is a flowchart of a process for generating virtual markers for journey activities, according to example embodiment(s);

FIG. 6 is a diagram of user mobility patterns, according to example embodiment(s);

FIG. 7 is a diagram of user unfamiliarity patterns, according to example embodiment(s);

FIGS. 8A through 8E are diagrams of example user interfaces with VR/AR representations, according to example embodiment(s);

FIG. 9 is a diagram of a geographic database, according to example embodiment(s);

FIG. 10 is a diagram of hardware that can be used to implement example embodiment(s);

FIG. 11 is a diagram of a chip set that can be used to implement example embodiment(s); and

FIG. 12 is a diagram of a mobile terminal (e.g., handset or vehicle or part thereof) that can be used to implement example embodiment(s).

### DESCRIPTION OF SOME EMBODIMENTS

Examples of a method, apparatus, and computer program generating virtual markers for journey activities are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

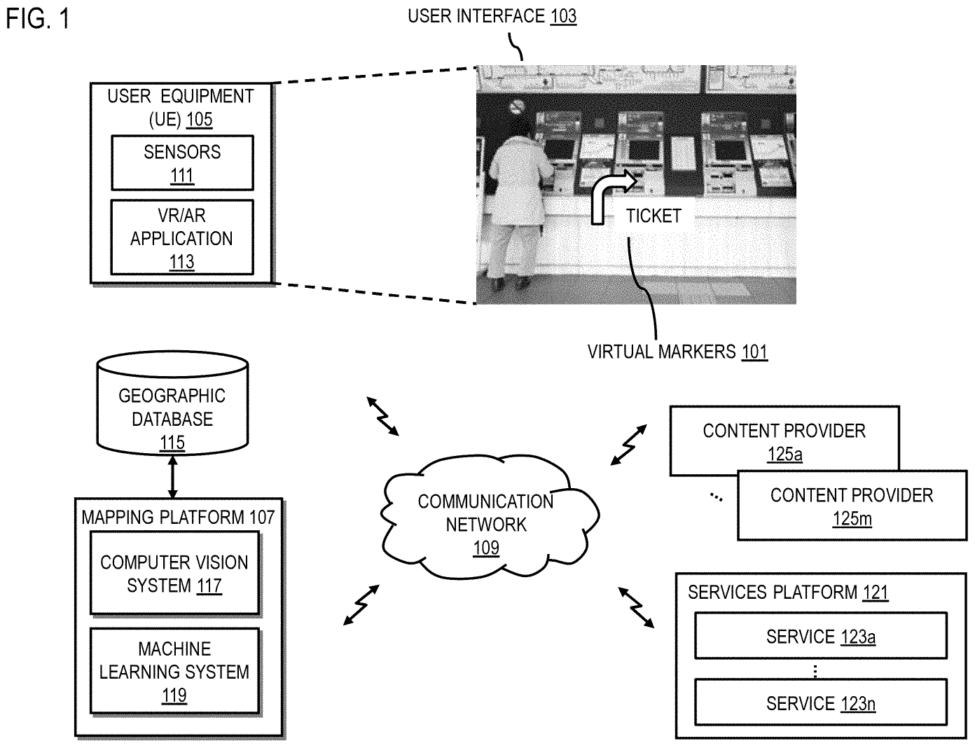

FIG. 1 is a diagram of a system capable of generating virtual markers for journey activities, according to an example embodiment(s). Users often travel to new/unfamiliar areas or are faced with new/unfamiliar activities (e.g., new modes of transport, new ticketing procedures, etc.) along their trips or journeys. This problem can be particularly acute during multi-modal journeys that have different travel legs that use different modes of transport requiring a user to transition from one mode of transport (e.g., walking) to another mode of transport (e.g., a train). These transitions can often create fear or anxiety when a user is not familiar with how to make the transition or with the location where the transition is to occur. Therefore, navigation and mapping service providers face significant technical challenges with respect to leveraging technology to help people planning a trip or journey (e.g., a multi-modal trip) to feel more comfortable with the least familiar parts of the journey, or to help people who are not familiar with some part of journey to get over their fear.

To address these technical problems, a system 100 of FIG. 1 introduces a capability to use virtual reality (VR) and augmented reality (AR) technology to provide a specifically tailored VR and AR experiences that familiarize users with journey activities by linking the VR and AR experiences through virtual markers (e.g., virtual marker 101). For example, the system 100 allows users planning a trip to be familiarized with the most relevant part(s) of a journey by creating a VR environment dedicated and tailored to the areas and/or activities of the journey the user is not familiar with. In other words, the system 100 can create a simulated VR world in which the user can experience a journey and/or activities associated with the journey to become more familiar with the journey and/or related journey activities. In one embodiment, as part of the creating the VR environment, the system 100 generates virtual markers that are experienced in the VR environment and can then be presented again in an AR environment when the user is physically located at the journey locations simulated in VR or physically performing the journey activity simulated in VR. Accordingly, the virtual markers presented through AR can advantageously remind the user of the previously experienced VR simulation, thereby potentially reducing fear or anxiety with experiencing unfamiliar journeys and/or journey activities.

In summary, the system 100 identifies the most relevant part of a journey (e.g., multi-modal journey) to be presented to the user. In one embodiment, the relevant part of the journey can be determined based on familiarity of the user with the journey area and/or journey activity (e.g., by processing historical user mobility data to determine number of visits to the area and/or number of times performing the journey activity). The system 100 then computes a virtual reality world for those specific locations and generates virtual markers 101 in this VR world that are intended to hep the user get familiar with the unfamiliar area or activities. If the user then uses an AR headset in a physical journey corresponding to the VR world, the system 100 surfaces those virtual markers 101 in the real world to remind the user of the past VR experience and to make the physical journey easier on the user.

As used herein, the term “virtual marker” refers to a representation (e.g., visual and/or audio representation) of a navigation or other guidance marker generated in a VR world that is intended to assist a user and/or a group of users to get familiar with an unfamiliar area planned to travel to later (e.g., transfers during a multi-modal trip). For example, in one embodiment, the virtual marker can be used to mark locations (e.g., train platforms), objects (e.g., ticket kiosks), etc. associated with traveling through an unfamiliar journey area or performing an unfamiliar journey activity (e.g., buying a train ticket a ticket kiosk at an unfamiliar location). In other embodiments, the virtual marker can identify areas in the VR world where a user took a correct or incorrect action to remind the user of that action when the user is physically at the location represented in the VR world. In one embodiment, the virtual marker can be presented on an augmented reality (AR) user interface to the user(s) when physically travelling in the area, to remind the user(s) of the VR experience and to make the journey easier. The virtual marker may be repeated in VR before and/or after the physical journey, until the user(s) reaches a desired level of familiarity.

More specifically, in one embodiment, the system 100 allows a user to get familiarized with a planned multi-modal trip using virtual markers 101 in VR that simulates the trip, and then present the virtual markers 101 in AR guiding the user when actually taking the trip. To tailor to the user's individual needs, the system 100 can create a VR environment via a user interface 103 of an user equipment (UE) 105 (e.g., a headset, a smart phone, smart glasses, heads-up-display (HUD), etc.) showing the most relevant part(s) of the journey that the user is unfamiliar with. It is noted that the use of user familiarity to determine a relevant part of the journey or journey activity to present is provided by way of illustration and not as a limitation. It is contemplated that the system 100 can use any other method or process for determining the relevant part of the journey or journey activity such as, but not limited to, user preference, available time to experience the VR environment, etc. In addition, although the various embodiments are discussed with respect to providing the VR experience before the AR experience, it is contemplated that the AR experience can occur before the VR experience such that the virtual markers 101 are generated based on the AR experience for presentation in a subsequent VR experience. For example, a user may want to be reminded of a real-world journey, journey activity, and/or related experience in the real world that was captured as part of an AR experience for replay or reminding in a subsequent VR experience.

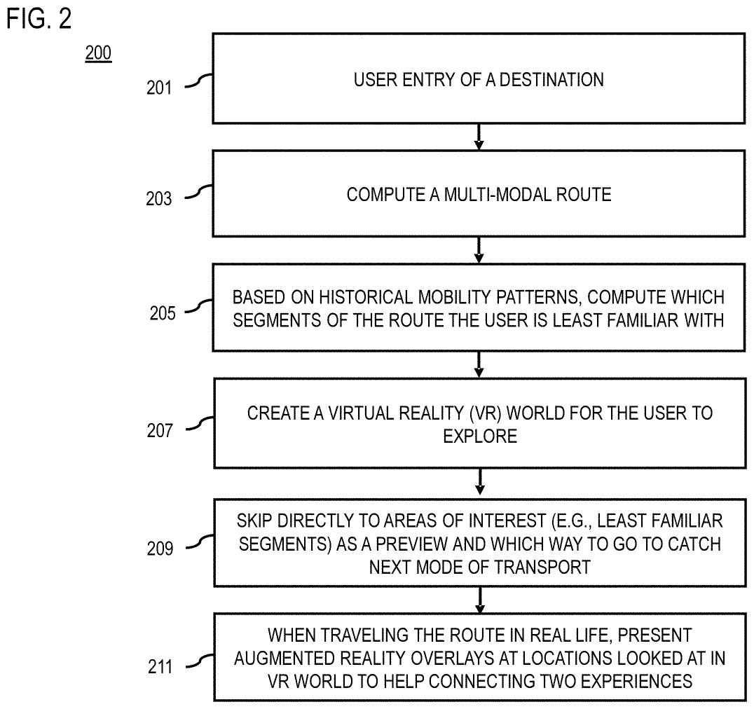

As VR headsets get more compact and affordable, they become more popular for consumers. Most VR headsets are standalone with a computer, a stereoscopic head-mounted display, stereo sound, WiFi components, a tracking system, etc. built-in. Some VR headsets also include eye tracking sensors and hand controllers. FIG. 2 is a flowchart of a process 200 for providing tailored multi-modal navigation assistance via virtual markers, according to example embodiment(s). In this embodiment, for example, in step 201, the system 100 can prompt a user to enter via the UE 105 a destination. In another embodiment, the system 100 can process sensor data collected from the UE 105 to determined user context, preferences, etc., thereby inferring the destination.

In step 203, based on the destination, the system 100 can compute a multi-modal route, that typically contains a combination of modes of transport (e.g., subway, long distance train, etc.) and multiple connections/changes. In step 205, based on historical mobility patterns/data of the user, the system 100 can compute one or more segments of the multi-modal route wherein the user is unfamiliar with, such as the connections between transport modes (e.g., from a bus to a subway), the connections between route legs of the same transport mode (e.g., from a red line train to a blue line train, from Main Street to Woodland Street, taking an elevator, taking an escalator, walking via a pedestrian underpass/overpass/bridge, etc.), or a combination thereof.

In step 207, the system 100 can create a virtual reality world with virtual markers 101 in the unfamiliar segments, the multi-modal route, or a combination thereof, for the user to explore on the user interface 103 (e.g., on a VR headset). In step 209, the system 100 can allow the user can conveniently skip directly to segments of interest (i.e., a least familiar segment), to get a preview of what awaits there and how go to catch the next mode of transport (e.g., train, subway, bus, etc.), such as which way to go (e.g., entering a station, making a turn, going down an escalator, which stop to get off, etc.), what to do (e.g., buying a ticket), when to do actions (e.g., waiting how long on the platform), etc.

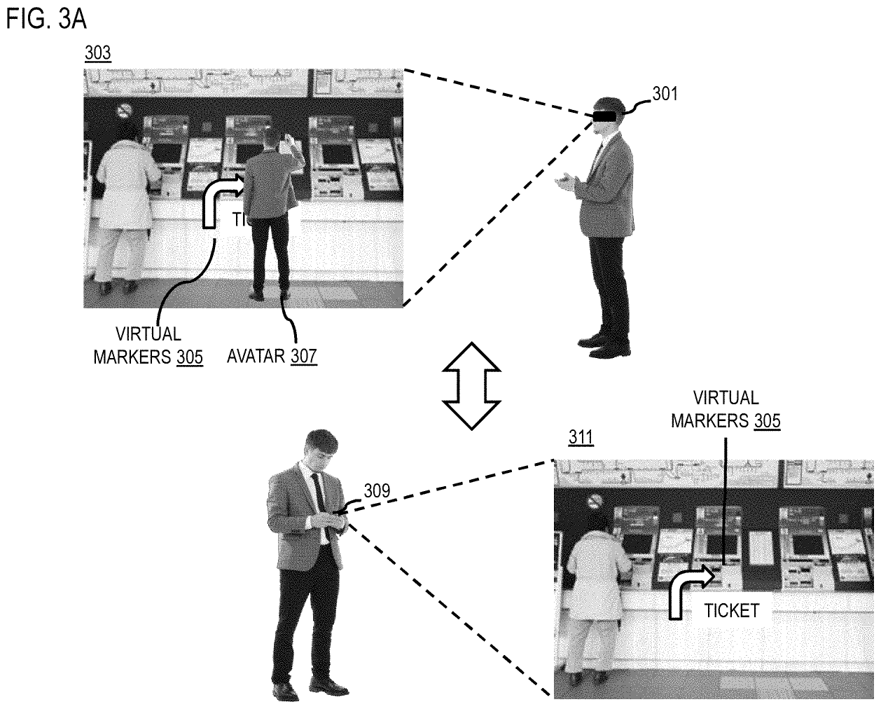

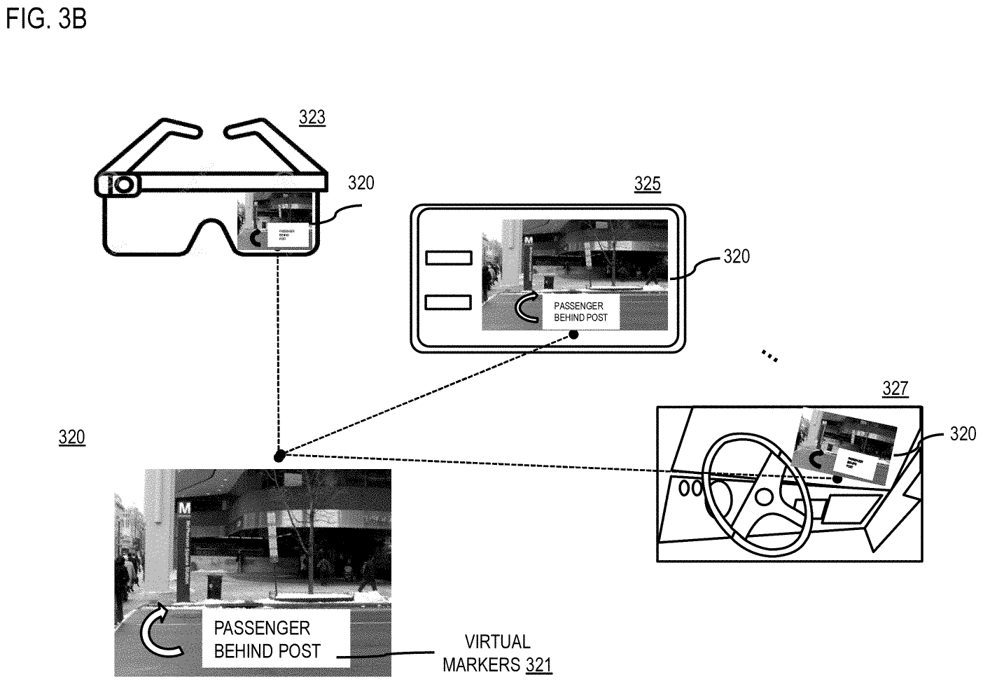

FIG. 3A is a diagram of a user transitioning between VR and AR, according to example embodiment(s). In an illustrative example use case depicted in FIG. 3A, the user can wear a VR headset 301 to experience a subway ticket machine. In this instance, the VR headset 301 presents a VR of the subway ticket machine on a VR user interface 303 which is overlaid with virtual markers 305 (e.g., an arrow pointing at the subway ticket machine, a cue of “ticket”, etc.), and optionally an avatar 307 resembling the user, for example. The avatar can be any icon, symbol, character, etc., and the cue can be in any language(s) that the user can understand.

In step 211, when the user actually travels on the multi-modal route in real life, the system 100 can provide augmented reality overlays of the virtual markers 101 on a user interface (e.g., a navigation user interface) at segments wherein the user explored in the VR world, thereby connecting the two experiences. In FIG. 3A, the user is navigating with a smart phone 309. When the user is approaching the subway ticket machine, the system 100 can overlay the virtual markers 305 on an AV user interface 311, to guide the user to purchase a ticket as experienced in the VR world.

In one embodiment, the system 100 can repeat step 209 as many times as required by the user to practice/train for intended actions/maneuvers (e.g., buying the ticket), for example to reach a level of proficiency. Such proficiency may be a time limit, such that the user can have enough time to get to subsequent actions/maneuvers. By way of example, the user needs to get the ticket in 3 minutes so to catch an airport express train.

In another embodiment, the system 100 can repeat step 211 as many times as necessary until the user completes the intended actions/maneuvers (e.g., buying the ticket).

In yet another embodiment, the user, and/or the system 100 may determine that the user needs more practice/training in the VR environment, for example, based on user performance during the multi-modal route. By way of example, the user took more than 10 minutes to buy the ticket. The system 100 can invite the user to re-take the practice/training in the VR environment, so the user will do better next time taking the multi-modal route. The more the user practices/trains in the VR environment, the user is better prepared for the actual execution in the real-world using AR navigation guidance overlays. By knowing who, what, when, where, why, how associated with each action/maneuver, the user can decide to focus attentions and disregard irrelevant objects/incidents.

In addition, the system 100 supports the user to focus on unfamiliar segments, such that the user has full discretion to receive or disregard the VR practice/training per segment, instead of it being forced upon to take the VR practice/training for the whole multi-modal route.

In one embodiment, the virtual markers 101 may be shown once. In another embodiment, the virtual markers 101 may be repeated periodically (e.g., every second), on demand, etc. based on the user's travel speed and the context around the user, as the user continues the route in the physical world. Whenever the user needs further virtual markers, the system 100 will present the virtual markers on areas and/or object surfaces in the live image of the UE 105 as the areas and/or the object surfaces used in the VR environment, for the user's convenience and familiarity.

Therefore, the system 100 can create a specifically tailored VR experience for a user planning to travel, based on the user's unfamiliarity with one or more of the route legs and connections. The system 100 can provide advantages including: making a user more comfortable travelling after playing/simulating a journey or the most unfamiliar part of the journey in the user's mind, making people keener to travel, as they becoming less afraid of possible troubles during the journey (especially for people not used to travelling) when do not how to react, generating more usage for trains, flights and other transport modes, reducing need for other assistance by people in trains stations, airports, etc., reducing delays due to waiting for people looking for their ways to make connections, reducing missed trains and planes, avoiding danger to people wandering around looking for their way, etc.

Although various embodiments are described with respect to taking a multi-modal trip, it is contemplated that the approach described herein may be used with other mobility-related services (e.g., ride-hailing, vehicle sharing, etc.), tourism services (e.g., city tours, theme parks, entertainment, etc.), entertainment (e.g., location-based gaming), flight simulation, retail (e.g., ATM, theatre ticketing, etc.), industrial manufacturing (e.g., machinery operating), repair and maintenance services, warehousing, package delivery, medical services (e.g., patient transport, operations, etc.), real estate (e.g., homes for sale open houses), etc. that can benefit from interchanging between VR and AR location-based experiences. By analogy, the system 100 can make people familiar with these location-based experiences or portion(s) of them, by showing the simulations in VR (e.g., how to unlock a shared vehicle, get to drive it, and return it), so that the users can use such services in the physical world later.

The virtual markers 101 can be shown on one area/surface or across multiple areas/surfaces if needed, to maintain readability. The system 100 and/or the user can define the duration of the virtual markers 101. In one embodiment, the duration may be a max number of seconds after a proximity trigger (e.g., when the user physically passes a surface overlaid with the virtual markers 101). In one embodiment, the duration may be a max number of seconds based on some visual acknowledgment by the user (e.g., when the user has seen the virtual marker 101). For example, the system 100 may terminate projecting one or more virtual markers 101 on a respective area/surface in the live image upon detecting the user's gaze at the area/surface and/or the user's gaze moving away from the area/surface. There may be other forms of acknowledgement (e.g., voice, gesture, etc.). In one embodiment, the system 100 applies a fading effect to make the virtual marker 101 gently disappear after the set seconds, instead of disappearing sharply.

As such, the user can view navigation and/or maneuver guidance at areas/surfaces in the live image at the user's discretion along the route. In one embodiment, the system 100 continues updating the virtual markers 101 by repeating the process of computing, generating, and presenting virtual marker 101 until the user reaches a destination.

In one embodiment, the system 100 of FIG. 1 may include the UE 105 (e.g., a headset, a mobile device, a smartphone, etc.) having connectivity to a mapping platform 107 via a communication network 109. In one embodiment, the UE 105 includes one or more device sensors 111a-111n (also collectively referred to herein as device sensors 111) (e.g., positioning sensors, inertial measurement units (IMUs), barometer, light sensors, etc.) and one or more applications (e.g., a VR/AR application 113, a navigation application, a mapping application, etc.). The positioning sensors can apply various positioning assisted navigation technologies, e.g., global navigation satellite systems (GNSS), WiFi, Bluetooth, Bluetooth low energy, 2/3/4/5G cellular signals, ultra-wideband (UWB) signals, etc., and various combinations of the technologies to derive a more precise location. By way of example, a combination of satellite and network signals can derive a more precise location than either one of the technologies, which is important in many intermodal scenarios, e.g., when GNSS signals are unavailable in subway stations. In one embodiment, the system 100 can provide a geofence based on the location of the VR environment. To effectively activate the AR device later, the system 100 can use positioning sensor data to determine the area corresponding to the VR world. By communicating the geofence corresponding to the VR environment, an AR device (e.g., UE 105) can activate itself and/or notify the user when approaching the area.

In one instance, the UE 105 (e.g., a mobile device) and/or the VR/AR application 113 can enable a user to request virtual markers 101 to guide the user to a selected destination (e.g., an office, an airport terminal, a museum, etc.).

In another embodiment, the UE 105 is a heads-up-display (HUD) system added-on or built-in a vehicle (e.g., standard vehicles, autonomous vehicles, highly automated driving (HAD) vehicles, semi-autonomous vehicles, etc.). In one embodiment, the vehicle may include one or more vehicle sensors (e.g., GPS sensors, etc.) functioning similar to the sensors 111, and the vehicle has connectivity to the mapping platform 107 via the communication network 109. By way of example, the system 100 can provide VR driving practice to a user first for a multi-modal trip, then provide AR guidance when the user is driving a vehicle via the city, picking up a passenger, boarding on a ferry, and/or parking in an airport, etc. based on the user's unfamiliarity with different segments of the trip. FIG. 3B is a diagram of various types of user equipment supporting AR projections to a vehicle user to pick up a passenger, according to example embodiment(s). An AR user interface 320 in FIG. 3B that is overlaid with virtual markers 321 (e.g., a turn arrow and a cue “Passenger behind post”), cab be presented on a smart glass 323, a smart phone 325, a HUD 327, etc. to guide the user to pick up a passenger.

In the VR mode, the system 100 can use the destination and/or the inter-modal route data to import corresponding 3D map data from a geographic database 115 that models the real world environment in the proximity of the inter-modal route and/or unfamiliar segments, and create a VR world of one or more unfamiliar segments of the route accordingly. In one embodiment, the VR world can correspond to an area of a given shape in the real world. Based on this area, a geofence can be created and transmitted to an AR device (e.g., UE 105), so that when the AR device enters/approaches the area, the AR device can activate itself and/or notify the user of the availability of AR assistance for the area corresponding to a particular route segment. The system 100 can then create and project the virtual marker 101 (e.g., via the mapping platform 107 and/or the VR/AR application 113) based on user context onto the user interface 103 of the UE 105, to guide the user.

In the AR mode, the system 100 can use sensor data from the UE 105 or a vehicle to determine a current location and an orientation of the user interface, then retrieve the virtual markers 101 corresponding to the current location as well as 3D map data from the geographic database 115, and augment the virtual marker 101 onto live images of one or more unfamiliar segments of the route accordingly. Based on the 3D map data, the system 100 can determine areas/surfaces in a live preview or a field of view used in the VR mode to augment the virtual marker 101.

The virtual marker 101 may be a graphic indicia (e.g., traffic and/or directional symbols such as turn, stop, etc., such as a straight arrow sign in a hexagon box), a textual description or explanation of the navigation guidance along an route (e.g., “ticket machine 10 m on the right” in a rectangular box) and/or maneuver instructions (e.g., “buy a ticket to ABC station” in in a rectangular box), etc. In one embodiment, the system 100 adapts the color, texture, size of the virtual markers 101 based on the color, size, and other restriction of the respective area/surface (e.g., a ticket machine) it is projected on, to ensure the virtual marker 101 is visible and/or readable. The information of the color, size, and other characteristics of the area/surface may be included in the 3D map data from the geographic database 115. Concurrently or alternatively, the information of the color, size, and other characteristics of the area/surface may be extracted by the system 100 using computer vision algorithms (e.g., via a computer vision system 117 of the mapping platform 107).

In addition to or in place of the visual presentations, the system 100 can render the VR/AR guidance or instructions in one or more audible formats, such as 2D or 3D sound effects to be symbolic, realistic, musical, etc.

In one embodiment, the system 100 also determines whether to project additional information types, such as tourist information, reminders, SMS/messages/tweets, weather, etc., based on a user's preference, familiarity, calendar, etc.

The above-described embodiments can help users to plan a multi-modal trip and train for familiarity, thus feeling more comfortable with the least familiar parts of the journey, by going over unfamiliar portions of a multi-modal journey in a virtual reality world then implementing the experience in the physical world via virtual markers on an augmented reality user interface.

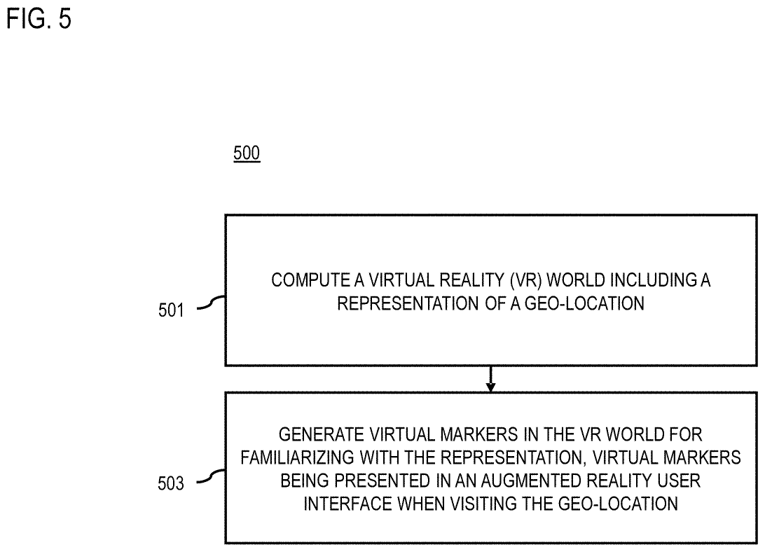

FIG. 5 is a diagram of the components of the mapping platform 107, according to example embodiment(s). By way of example, the mapping platform 107 includes one or more components for providing tailored multi-modal navigation assistance via virtual markers, according to the various embodiments described herein. It is contemplated that the functions of these components may be combined or performed by other components of equivalent functionality. In one embodiment, the mapping platform 107 includes a data processing module 401, a virtual reality module 403, a unfamiliarity score module 405, an augmented reality module 407, an output module 409, the computer vision system 117, and the machine learning system 119. In another embodiment, the computer vision system 117, and the machine learning system 119 are independent from the mapping platform 107, and the mapping platform 107 has connectivity to the geographic database 115, the computer vision system 117, and the machine learning system 119.

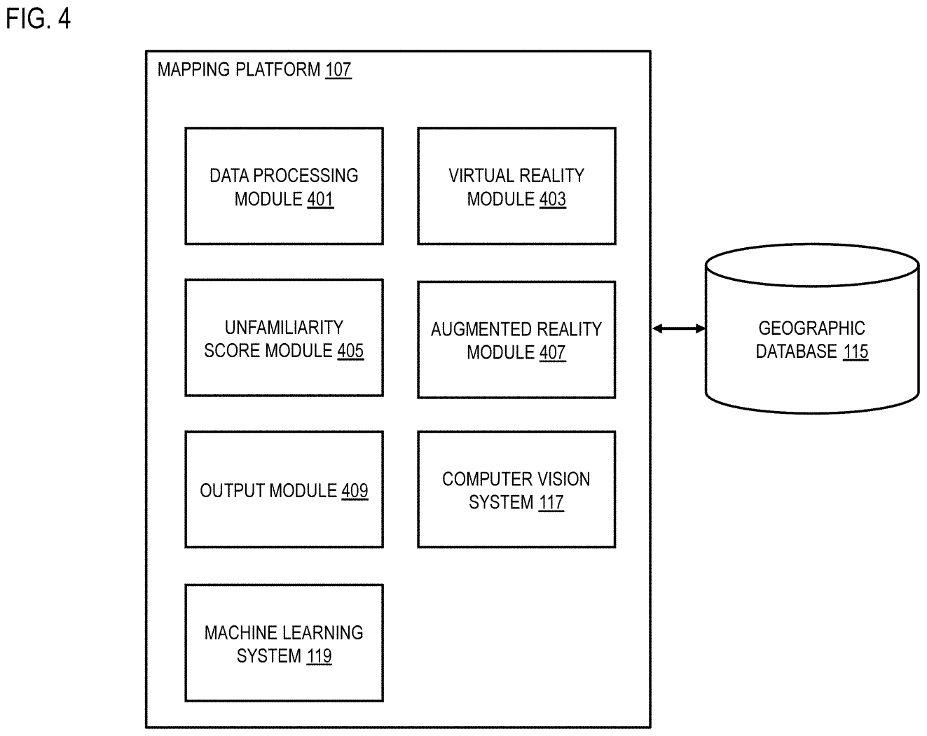

The above presented modules and components of the mapping platform 107 can be implemented in hardware, firmware, software, or a combination thereof. Though depicted as a separate entity in FIG. 1, it is contemplated that the mapping platform 107 may be implemented as a module of any other component of the system 100. In another embodiment, the mapping platform 107 and/or the modules 401-409 may be implemented as a cloud-based service, local service, native application, or combination thereof. The functions of the mapping platform 107, the modules 401-409, the computer vision system 117, and/or machine learning system 119 are discussed with respect to FIGS. 4-8.

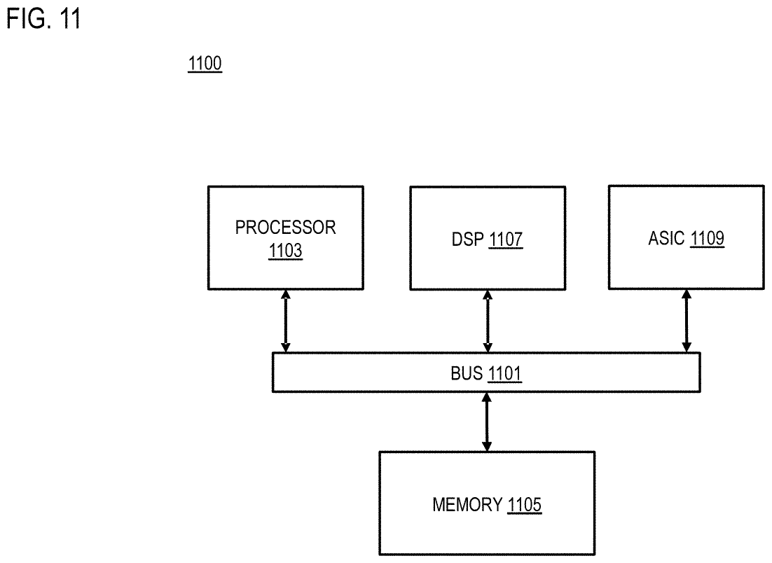

FIG. 5 is a flowchart of a process for providing tailored multi-modal navigation assistance via virtual markers, according to example embodiment(s). In various embodiments, the mapping platform 107, the computer vision system 117, the machine learning system 119, and/or any of the modules 401-409 may perform one or more portions of the process 500 and may be implemented in, for instance, a chip set including a processor and a memory as shown in FIG. 11. As such, the mapping platform 107, the computer vision system 117, the machine learning system 119, and/or the modules 401-409 can provide means for accomplishing various parts of the process 500, as well as means for accomplishing embodiments of other processes described herein in conjunction with other components of the system 100. Although the process 500 is illustrated and described as a sequence of steps, its contemplated that various embodiments of the process 500 may be performed in any order or combination and need not include all the illustrated steps.

In one scenario, the data processing module 401 can compute a multi-modal route comprising at least two modes of transport, for example, using a user destination and multi-modal routing. In one embodiment, in step 501, the virtual reality module 403 can compute a virtual reality world including a representation of a geographic location. The geographic location is associated with a multi-modal route. By way of example, the geographic location is selected from one or more unfamiliar locations, such as a connection location of the multi-modal journey. In this example, the virtual reality world simulates a transition at the connection location between a first transport mode and a second transport mode of the multi-modal journey.

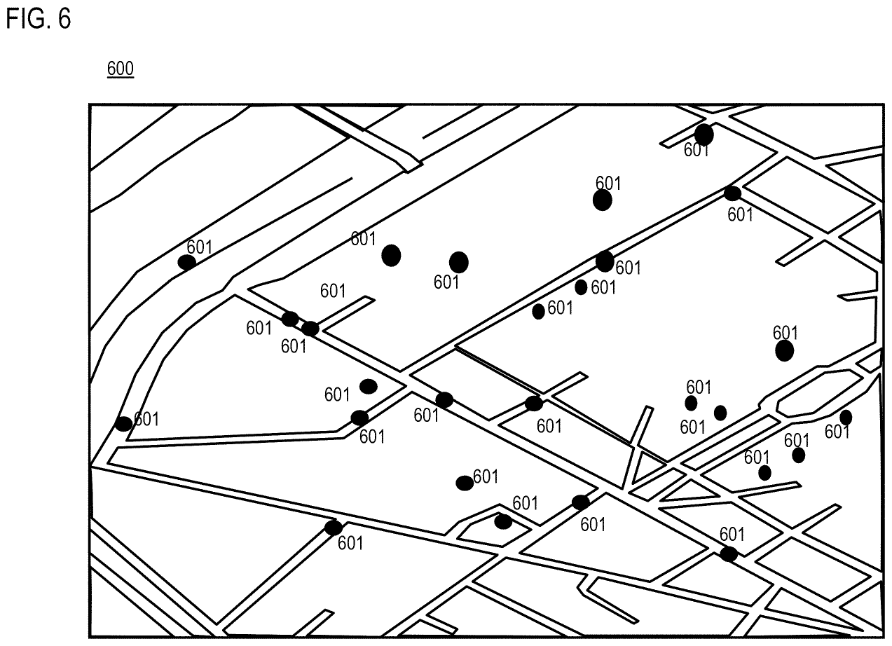

In one embodiment, the unfamiliarity score module 405 can process historical mobility data (e.g., a user's mobility graphs, historical mobility patterns, etc.) to determine the one or more unfamiliar locations. FIG. 6 is a diagram of user mobility patterns, according to example embodiment(s). The familiarity and/or unfamiliarity of a user (e.g., one individual) or a group of users (e.g., a tour group from a non-English speaking country) for a given area or location can be computed based on how frequently the user(s) has/have stayed and/or passed through that area/location in the past or recently, using the mobility graphs (i.e., historical mobility patterns), a multi-modal journey (including an origin and a destination), user profile(s), etc. as input data.

By way of example, the one or more unfamiliar locations are determined based on a number of visits indicated in the historical mobility data. A map 600 in FIG. 6 depicts block dots 601 with sizes proportional to numbers of times of user visits, aggerated time lengths of the user visits, or a combination thereof. In another embodiment, such map can depict user trajectories during a time period, such as last week, month, season, year, etc.

In one embodiment, the historical mobility data is one user's personal historical mobility data. In another embodiment, the historical mobility data is an aggregated dataset of a user group, for identifying locations which result unfamiliar to a majority of the users in the group. By way of example, some tourists may visit the city for the first time, and the other for the second or more times and visited different parts of the city, such as only a proportion of the group who need more assistance to find their way around.

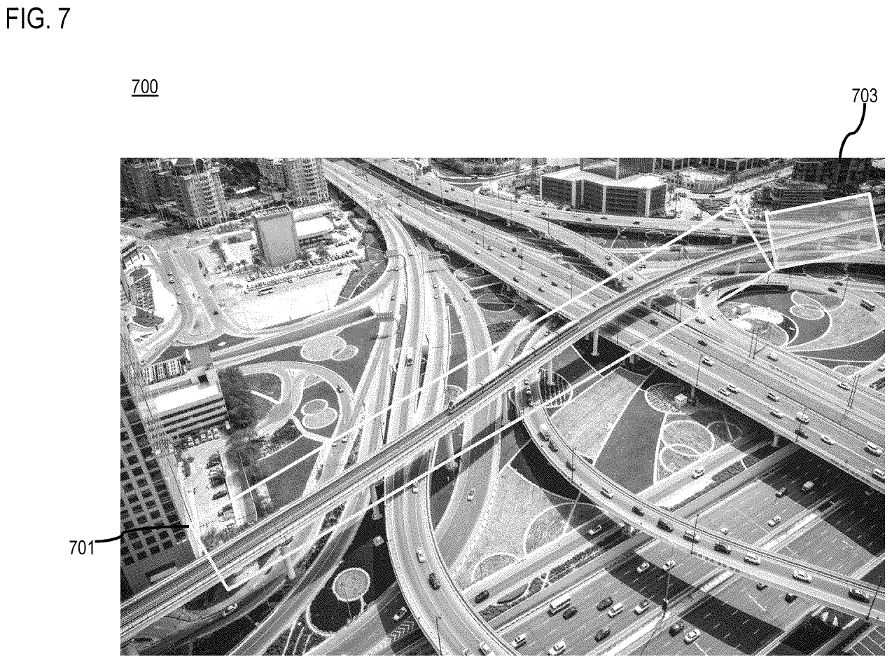

In another embodiment, the unfamiliarity score module 405 can process the historical mobility data (e.g., historical user trajectories) to determine respective unfamiliarity scores for the one or more unfamiliar locations. By way of example, the unfamiliarity scores can be computed based on the numbers of times of user visits, aggerated time lengths of the user visits, or a combination thereof. In this case, the geographic location for VR simulation can be selected based on the respective unfamiliarity scores. FIG. 7 is a diagram 700 of user unfamiliarity patterns, according to example embodiment(s). In the image of FIG. 7, a rectangular pattern 701 marking a segment of the train track as an area that the user is familiar with (i.e., with a low unfamiliarity score), while another rectangular pattern 703 marking a segment of the train track as an area that the user is unfamiliar with (i.e., with a high unfamiliarity score). As such, the segment marked by the pattern 703 with the high unfamiliarity score (e.g., meeting or exceeding a threshold) is selected to generate a VR simulation for the user to practice/train to travel via the segment. In one embodiment, the pattern 703 (where the VR simulation took place) is passed along to the AR device (e.g., UE 105) as a geofence, which can be applied to activate the AR device, to notify the user of the coming AR available area, etc.

In various embodiments, the virtual reality world can be computed to simulate a designated context at the geographic location, such as a designated time constraint at the geographic location, etc. For example, the designated time constraint is based on a time availability for experiencing the virtual reality world (e.g., to attend a meeting/appointment within a time slot, to visit a point of interest during open hours, to play a timed location-based game, etc.), a connection time between legs of a multi-modal journey (e.g., to transfer to a bus/subway/ferry/flight, to pick up the next passenger, to deliver the next package, etc.), or a combination thereof.

In one embodiment, the virtual reality module 403 can measure timing of one or more physical actions of the user during the virtual reality simulation against the timing constraint data to provide one or more training results. The virtual reality module 403 can render the one or more training results on the user interface to prompt the user to decide whether to train more.

Other example designated context at the geographic location may be a time of the day (e.g., morning, afternoon, evening, rush hours, etc.), weather, transport crowdedness, local events (e.g., festivals, parades, pup-up booths, etc.), traffic, etc.

In addition to or in place of the unfamiliarity score, the virtual reality module 403 can determine a difficulty level (e.g., linguistically, intellectually, mentally, physically, etc. difficult for the user based on user context, preferences, education, culture background, etc.) of user actions to be performed during a connection. The virtual reality module 403 can selectively simulate the user actions in the virtual reality world based on the difficulty level. For example, a user on a wheelchair can take a different route (e.g., via an elevator, a handicap ramp, etc.) and/or different user actions at different difficulty levels to transfer to a subway.

In one embodiment, in step 503, the virtual reality module 403 can generate one or more virtual markers in the virtual reality world for familiarizing with the representation of the geographic location. As explained later, the unfamiliarity score module 405 can determine/extract the most relevant content. For instance, in the selected segments of the journey matching the least familiar segments for a user, the virtual reality module 403 can generate virtual markers in the virtual environment in order to help the user to stimulate the travel experience. Referring back to FIG. 3A, when some tickets are required to enter a train station, the virtual reality module 403 can use virtual markers to highlight in the VR world where to go, where to purchase those tickets, which exact tickets to purchase, how to pay for the tickets (especially if in a different language), where to stamp those tickets if required, etc.

The one or more virtual markers can be further presented in an augmented reality user interface based on detecting a physical journey to the geographic location, e.g., as shown in FIG. 3A. The one or more virtual markers are generated to indicate, to remind of, or a combination thereof an experience in the in the virtual reality world when presented in the augmented reality user interface. By way of example, the one or more virtual markers include an indication of a correct action (e.g., insert credit card), an incorrection action (e.g., no cash accepted), or a combination thereof taken in the virtual reality world to simulate travel at the geographic location.

In another scenario, the system 100 can use virtual markers generated in a VR environment to present an AR user interface when physically presenting at a corresponding location e.g., as shown in FIG. 3B. In this example, the data processing module 401 can determine a physical presence at a geographic location (e.g., a driver seeking a shared-vehicle passenger standing behind a subway signpost). The augmented reality module 407 can retrieve one or more virtual markers associated with the geographic location for AR overlays. For instance, the one or more virtual markers indicate a prior experience with a representation of the geographic location in a virtual reality world (e.g., the driver practiced the pick-up in the VR environment). The augmented reality module 407 can present the one or more virtual markers (e.g., a turn arrow and a cue “Passenger behind post”) in an augmented reality user interface (e.g., of a smart glass, a smart phone, a HUD, etc. to guide the driver to pick up a passenger) during the physical presence at the geographic location. In one embodiment, the virtual marker 101 includes navigation guidance information (e.g., go straight) and/or user maneuver instructions (drive and stop on the left side of the subway signpost).

In addition to or in place of the location triggers, the data processing module 401 can process UE sensor data to recognize user assistance seeking behaviors (e.g., pausing on the path/platform/intersection/etc., parking search behaviors, etc.) to surface virtual markers. The data processing module 401 can automatically start the virtual markers, or prompt the user to select an AR mode of navigation guidance.

By way of example, the one or more virtual markers include an indication of a correct action (e.g., stopping next to the signpost), an incorrection action (e.g., no parking), or a combination thereof taken in the virtual reality world to simulate travel at the geographic location. In another embodiment, the travel at the geographic location is via a multi-modal route, and the one or more markers is associated with a transition between a first mode of transport and a second mode of transport of the multi-modal route, e.g., as shown in FIG. 3A.

In one embodiment, the unfamiliarity score module 405 can determine that the geographic location is an unfamiliar location, and the virtual reality world is computed based on the determining that the geographic location is an unfamiliar location. For instance, the unfamiliar location can be determined based on a number of visits indicated in historical mobility data.

Taking travelling as an example, the most challenging parts can be the connections (e.g., between a train and a plane). For instance, when a user is unfamiliar with a part of a train route, the virtual reality module 403 does not need to simulate the whole train route (which is not deemed as the most relevant element of the trip. What is important to the user can be: Which station to get off (and/or “which are the stations before my stop?”)? What to do there and how to get to the next leg of the trip on time? Based on this, the unfamiliarity score module 405 can determine unfamiliarity scores of different parts of the trip and/or rank which parts of the train route are the most relevant for the VR simulation.

Based on the ranking (and the availability of data), the virtual reality module 403 can automatically generate the required environments, given trip constraints (e.g., time available for the user, etc.). In another embodiment, the virtual reality module 403 can recommend to the user the most relevant parts, or several relevant parts for the VR simulation. The user can decide among multiple user experiences: (1) Play all of the relevant sections to get familiar with the critical parts of the journey; (2) Play and generate interactive sessions to get familiar with the critical parts of the journey and know exactly what to do there and how; (3) Play the most relevant sections in a timeboxed manner, e.g., 15 minutes, when the user has limited time, etc.

In another embodiment, the virtual reality module 403 can simulate more details/circumstances of the trip experiences, such as night, rain, busy station, empty, etc. so that anxious travelers could get prepared for different scenarios, under user time constraints. The function can be triggered by a user input, or as determined based on the system's prediction of likely travel circumstances. The likely travel circumstances can be predicted using historical and/or real-time mobility data of train users, train schedule data, etc.

In yet another scenario, the system 100 can generate virtual markers in AR for presentation in an VR environment. In one embodiment, the data processing module 401 can determine a physical presence at a geographic location. The augmented reality module 407 can compute an augmented reality user interface overlaid on imagery of the geographic location (e.g., using computer vision), and generate one or more virtual markers in the augmented reality user interface for familiarizing with travel at the geographic location. By way of example, some virtual markers of a location-based game (e.g., Pokémon GO®) are generated. The one or more virtual markers can be further presented by the virtual reality module 403 in a virtual reality world computed to represent the geographic location, such that the user can practice the game in a VR environment.

In another example, the travel at the geographic location is via a multi-modal route as shown in FIG. 3A, and the one or more markers is associated with a transition between a first mode of transport and a second mode of transport of the multi-modal route. In this case, after the user physically took the multi-modal route and used the ticket machine (e.g., for the first time), yet wants more practice of using the ticket machine in the VR environment so to speed up the next time (e.g., the user is staying in the area for one month and will take the multi-modal route every weekend days).

In one embodiment, the one or more virtual markers include an indication of a correct action (e.g., go down escalator), an incorrection action (e.g., wrong way, go back upstairs), or a combination thereof taken during the travel at the geographic location. By way of example, the geographic location is determined by the unfamiliarity score module 405 based on respective unfamiliarity scores associated with one or more candidate unfamiliar locations (e.g., a ticket machine, a fare gate, a turnabout, a five-way junction, an airport terminal, etc.).

In one embodiment, the output module 409 outputs data for rendering the virtual reality environment (including virtual markers) to a see-through head-mounted display (HMD), after the virtual reality module 403 considers diffraction optics, holographic optics, polarized optics, reflective optics, etc. of the HMD when generating the VR rendering data.

In another embodiment, the output module 409 outputs data for rendering the augmented reality overlay (including virtual markers) to a smart phone, after the augmented reality module 407 considers display capabilities of the smart phone when generating the AR rendering data.

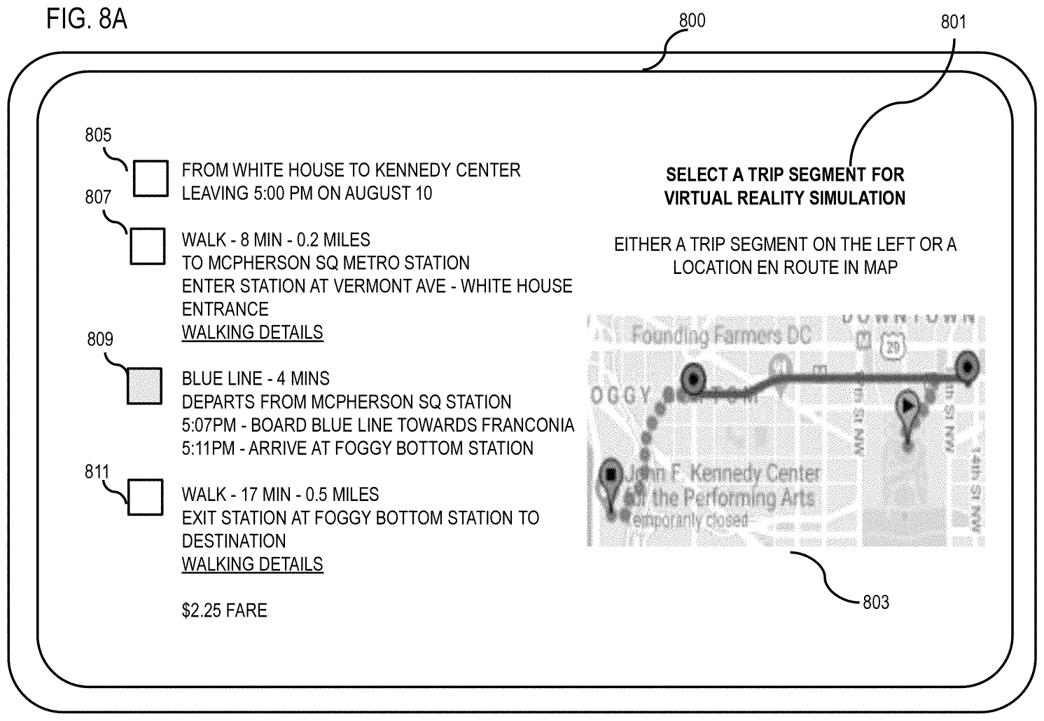

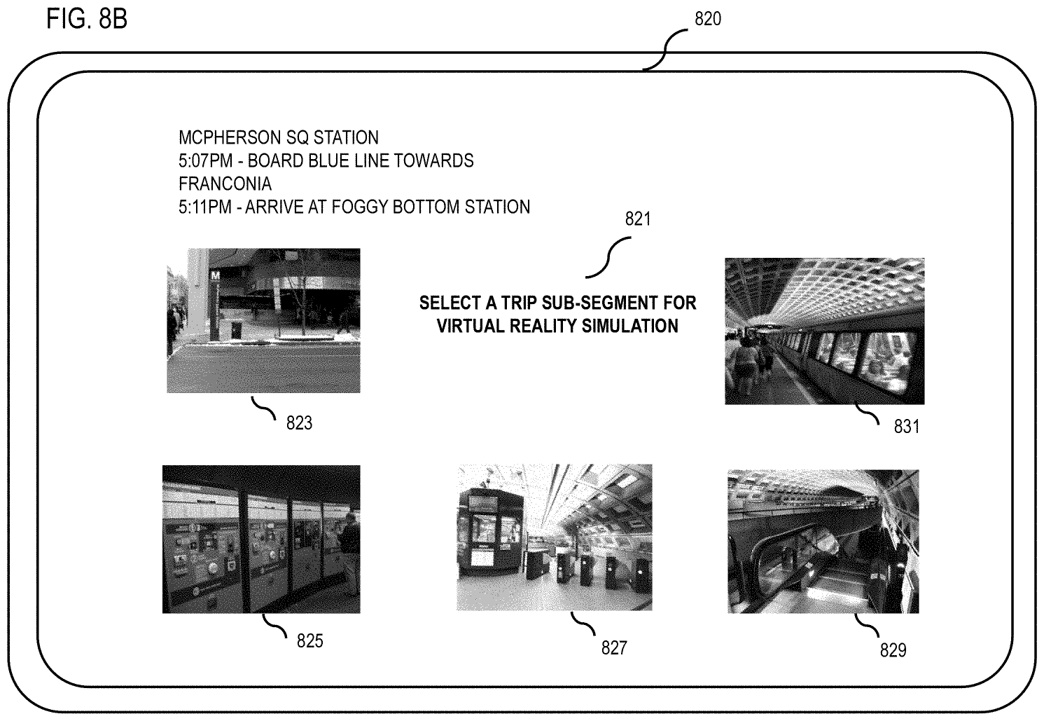

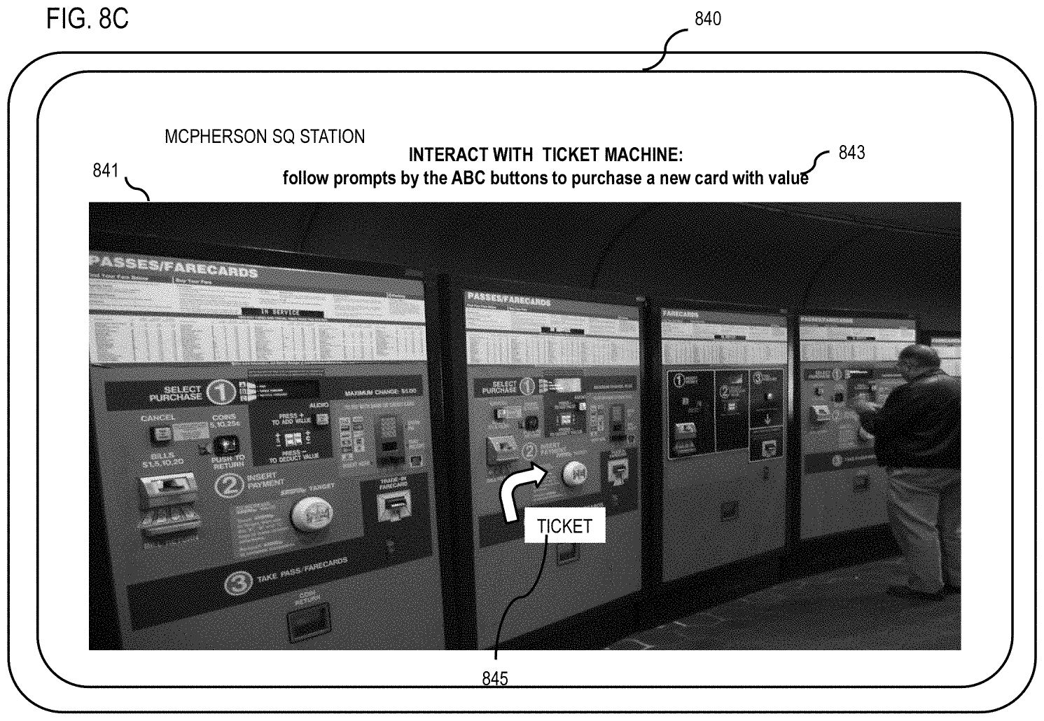

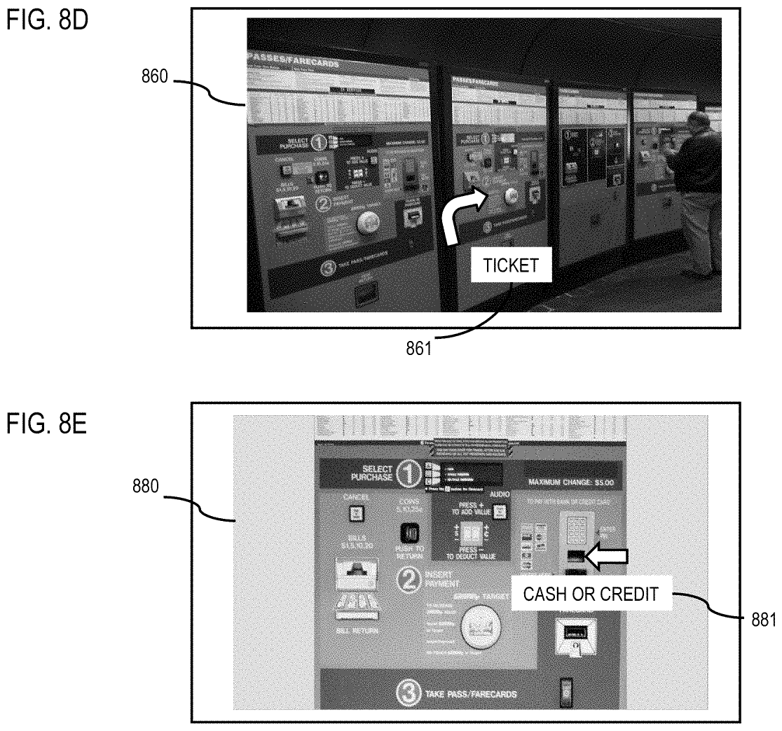

FIGS. 8A through 8E are diagrams of example user interfaces with VR/AR representations, according to example embodiment(s). FIG. 8A is a diagram of an example user interface 800 for determining a trip segment for VR simulation, according to example embodiment(s). By way of example, the user interface 800 displays instructions 801 of “select a trip segment for virtual reality simulation”, and “either a trip segment on the left or a location en route in map.” The user interface 800 also displays a map 803 showing an inter-modal route (e.g., from the White House to the Kennedy Center in DC), and a list of route segments that include the whole route 805, a walking segment 807, a subway segment 809, and another walking segment 811. The user interface 800 further displays an image 505 for the user select an object surface. By way of example, the subway segment 809 is selected in FIG. 8A.

Alternatively, the system 100 can recommend the user to select the subway segment 809 based on the unfamiliarity scores and/or the difficulty levels of the trip segments. In another embodiment, the system 100 can automatically select the subway segment 809 for the user based on the unfamiliarity scores and/or the difficulty levels of the trip segments.

FIG. 8B is a diagram of an example user interface 820 for determining a trip sub-segment for VR simulation, according to example embodiment(s). By way of example, the user interface 820 displays instructions 821 of “select a trip sub-segment for virtual reality simulation.” The user interface 800 also displays thumbnails of trip sub-segments that include a subway entry 823, a ticketing segment 825, a fare gate segment 827, an escalator segment 829, and a platform segment 831. By way of example, the ticketing segment 825 is selected in FIG. 8B.

Alternatively, the system 100 can recommend the user to select the ticketing segment 825 based on the unfamiliarity scores and/or the difficulty levels of the trip segments. In another embodiment, the system 100 can automatically select the ticketing segment 825 for the user based on the unfamiliarity scores and/or the difficulty levels of the trip segments.

In FIG. 8C, a user interface 840 presents an VR environment 841 of the ticketing segment 825. By way of example, the user interface 840 displays instructions 843 of “Interact with ticker machine: follow prompts by the ABC buttons to purchase a new card with value.” The VR environment 841 displays virtual markets 845 (e.g., an arrow pointing at the subway ticket machine, a cue of “ticket”, etc.). Once the VR environment 841 is triggered, the system 100 can dissect the ticketing segment 825 into maneuver instructions, such as selecting an one-time pass, selecting an amount of $20, paying by a credit card, etc. and guide the user step by step in the VR environment 841 using different virtual markers.

In FIG. 8D, a user interface 860 for an AR mode (e.g., virtual markers 861) can be triggered by the arrival at a corresponding location simulated in the VR environment 841 in FIG. 8C. In another embodiment, the virtual markers 861 can be triggered when the user activates the VR/AR application 113, a navigation application, etc. on the UE 105. In yet another embodiment, the virtual markers 861 can be triggered when the system 100 detects user assistance seeking behaviors (e.g., pausing on a path) from the sensors 111 and determines that the user needs the virtual markers including navigation guidance information and/or maneuver instructions.

Once the AR mode are triggered, the system 100 renders virtual markers according to dissected maneuver instructions in the VR environment 841. In FIG. 8E, a user interface 880 renders the AR mode corresponding to paying by a credit card, and virtual markets 881 (e.g., an arrow pointing at a credit card slot, a cue of “cash or credit”, etc.).

The areas/surfaces for presenting the virtual markers 101 can be user-selected for providing visual cues. The virtual marker rendering speed can be selected by user via a user interface as a fixed speed, or varied as the user manipulating the user interface such as moving a finger on a touch screen, dragging a mouse, etc. In one embodiment, the system 100 can determine the optimal timing to render the virtual markers 101, i.e., when the virtual markers 101 should be displayed and for how long (i.e., “rendering duration”) based on default settings, user actions, user preferences, user context, etc., so that the virtual markers 101 can be conveyed to the user. In addition, the system 100 can support a user to actively request virtual markers with a gaze.

In various embodiments, the system 100 may receive user selections via the UE 105 such as a touch screen, a touchpad, a button/switch, an eye tracking mechanism (capturing a user gaze), speech recognition (capturing a voice comment), gesture recognition (capturing a user gesture), a brain-computer interface (capturing brain waves), etc.

The virtual reality module 403 may provide data for incorporating 2D or 3D virtual markers 101 into areas/surfaces in the VR environment, etc. In terms of virtual graphic indicia markers, the virtual reality module 403 may adopt widely recognized symbol signs or the like or design its own graphic indicia. Regarding textual virtual markers, the virtual reality module 403 may adapt font sizes and colors based on user preferences, user vision, and sizes/resolutions of user interfaces/displays, etc. By way of example, the higher the resolution of a headset (e.g., 1440×1600), the more virtual marker content can be incorporated thereon.

Depending on the AR rendering device, the augmented reality module 407 may simply apply the same virtual markers used in the VR environment or adapt the virtual markers based on the display capabilities of the AR rendering device. The AR rendering device can use various projection techniques, such as parallel projection, perspective projection, etc. Regarding AR text overlays, the augmented reality module 407 may adapt font sizes and colors based on its own display capabilities. By way of example, the VR virtual markers of 1440×1600 are adapted for smart glasses with a resolution of 640×360.

In one embodiment, the output module 409 can output to the geographic database 115 the virtual markers 101 (including information types, instruction types, etc.), unfamiliarity scores, and/or respective user performance data in VR/AR, etc. corresponding to a user for future use and/or training of the machine learning system 119, to improve the speed and accuracy of the virtual marker 101 processes of the mapping platform 107.

In one embodiment, the data processing module 401 in connection with the machine learning system 119 select respective unfamiliarity scores, information types, contextual attributes (e.g., a transport mode, a travel speed, historical travel data, traffic data, calendar data, etc. associated with the user), virtual marker rendering timing attributes (including a rendering starting time, a rendering duration, a rendering end time, etc.), etc. tailored for the user(s). In one embodiment, the data processing module 401 can train the machine learning system 119 to select or assign respective weights, correlations, relationships, etc. among the unfamiliarity scores, the information types, the contextual attributes, the rendering timing attributes, or a combination thereof, for determining respective rendering virtual marker content and timing. In one instance, the data processing module 401 can continuously provide and/or update a machine learning model (e.g., a support vector machine (SVM), neural network, decision tree, etc.) of the machine learning system 119 during training using, for instance, supervised deep convolution networks or equivalents. In other words, the data processing module 401 trains the machine learning model using the respective unfamiliarity scores, the information types, the contextual attributes, the rendering timing attributes, or a combination thereof to most efficiently select the most relevant locations to render most revenant information with optimal rendering timing.

In one embodiment, the data processing module 401 can improve the virtual marker process using feedback loops based on, for example, user behavior and/or feedback data. In one embodiment, the data processing module 401 can improve a machine learning model for the virtual marker process using user behavior and/or feedback data as training data. For example, the data processing module 401 can analyze AR usage patterns data, user AR acknowledged commands, user missed directions (e.g., wrong platform) data, etc. to determine what virtual markers at where work best relative to user(s). In one instance, the machine learning system 100 can then adapts itself to better serve the user(s) by modifying, for example, color, texture, size of the visual/audio cues based on user feedbacks.

Using multi modal routing, mobility graphs (e.g., historical mobility patterns), relevant trip segment extraction, computation of a VR world matching those segments, indoor mapping, AR, computer vision, and machine learning algorithms, the above-described embodiments can personalize user experience with virtual markers 101 as AR guidance for unfamiliar portion(s) of a journey (e.g., a multi-modal trip). In particular, the above-described embodiments identify the most relevant part of the multi-modal journey to be presented to the user based on unfamiliarity, compute a virtual reality world for those unfamiliar areas/locations, generate virtual markers in the virtual reality world to help the user getting familiar with the unfamiliar areas/locations, and surface the virtual markers on an augmented reality user interface when the user is traveling in the real world to remind the user of the VR experience and to make this trip easier.

Besides taking a multi-modal trip, the above-described embodiments may be used with other mobility-related services (e.g., ride-hailing, vehicle sharing, etc.), tourism services (e.g., city tours, theme parks, entertainment, etc.), entertainment (e.g., location-based gaming), flight simulation, retail (e.g., ATM, theatre ticketing, etc.), industrial manufacturing (e.g., machinery operating), repair and maintenance services, warehousing, package delivery, medical services (e.g., patient transport, operations, etc.), real estate (e.g., homes for sale open houses), etc. that interchange between VR and AR location-based experiences.

Returning to FIG. 1, in one embodiment, the UE 105 can be associated with any person (e.g., a pedestrian), any person driving or traveling within a vehicle, or with any vehicle (e.g., an embedded navigation system). By way of example, the UE 105 can be any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, fitness device, television receiver, radio broadcast receiver, electronic book device, game device, devices associated with one or more vehicles or any combination thereof, including the accessories and peripherals of these devices, or any combination thereof. It is also contemplated that a UE 105 can support any type of interface to the user (such as “wearable” circuitry, etc.). In one embodiment, the vehicle may have cellular or wireless fidelity (Wi-Fi) connection either through the inbuilt communication equipment or from a UE 105 associated with the vehicle. Also, the UE 105 may be configured to access the communication network 109 by way of any known or still developing communication protocols. In one embodiment, the UE 105 may include the mapping platform 107 to provide tailored multi-modal navigation assistance via virtual markers.

In one embodiment, the UE 105 include device sensors 111 (e.g., GPS sensors, a front facing camera, a rear facing camera, multi-axial accelerometers, height sensors, tilt sensors, moisture sensors, pressure sensors, wireless network sensors, etc.) and applications (e.g., the AP application 113, mapping applications, navigation applications, shared vehicle booking or reservation applications, public transportation timetable applications, etc.). In one example embodiment, the positioning sensors can enable the UE 105 to obtain geographic coordinates for determining current or live location and time. The positioning sensors can apply various positioning assisted navigation technologies, e.g., global navigation satellite systems (GNSS), WiFi, Bluetooth, Bluetooth low energy, 2/3/4/5G cellular signals, ultra-wideband (UWB) signals, etc., and various combinations of the technologies to derive a more precise location. By way of example, a combination of satellite and network signals can derive a more precise location than either one of the technologies, which is important in many of the intermodal scenarios, e.g., when GNSS signals are not available in subway stations. Further, a user location within an area may be determined by a triangulation system such as A-GPS, Cell of Origin, or other location extrapolation technologies when cellular or network signals are available.

In one embodiment, the mapping platform 107 performs the process for providing tailored multi-modal navigation assistance via virtual markers as discussed with respect to the various embodiments described herein. In one embodiment, the mapping platform 107 can be a standalone server or a component of another device with connectivity to the communication network 109. For example, the component can be part of an edge computing network where remote computing devices (not shown) are installed along or within proximity of an intended destination (e.g., a city center).

In one embodiment, the machine learning system 119 of the mapping platform 107 includes a neural network or other machine learning system to compare and/or score (e.g., iteratively) a user's historical routes (e.g., travels and/or journeys) against computed navigation routes and/or an optimal computed navigation route. For example, when the inputs are factors and attributes of the respective routes, the output can include a relative ranking or scoring computation as to whether a historical route is the most relevant route (or route segment) to reference for the route comparison analysis. In one embodiment, the machine learning system 119 can iteratively improve the speed by which the system 100 ranks a user's historical routes and/or the likelihood that a user will ultimately select the optimal navigation route to the selected destination. In one embodiment, the neural network of the machine learning system 119 is a traditional convolutional neural network which consists of multiple layers of collections of one or more neurons (which are configured to process a portion of an input data). In one embodiment, the machine learning system 119 also has connectivity or access over the communication network 109 to the geographic database 115 that can store virtually marked features (e.g., applicable factors and attributes, questions, and/or corresponding information and data, etc.).

In one embodiment, the mapping platform 107 has connectivity over the communications network 109 to the services platform 121 (e.g., an OEM platform) that provides one or more services 123a-123n (also collectively referred to herein as services 123) (e.g., navigation/routing services). By way of example, the services 123 may also be other third-party services and include mapping services, navigation services, traffic incident services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services platform 121 uses the output (e.g. route ranking data, mobility graph data, etc.) of the mapping platform 107 to provide services such as navigation, mapping, other location-based services, etc.

In one embodiment, one or more content providers 125a-125n (also collectively referred to herein as content providers 125) may provide content or data (e.g., including road attributes, terrain data/topology, historical travel data for a user, health related information, weather, population models, traffic data, cellular coverage data, any relevant contextual information, etc.) to the UE 105, the mapping platform 107, the applications (including VR/AR application 113), the vehicle, the geographic database 115, the services platform 121, and the services 123. The content provided may be any type of content, such as map content, text-based content, audio content, video content, image content, etc. In one embodiment, the content providers 125 may provide content regarding movement of a UE 105, a vehicle, or a combination thereof on a digital map or link as well as content that may aid in localizing a user path or trajectory on a digital map or link (e.g., to assist with determining road attributes in connection with mobility history and travels). In one embodiment, the content providers 125 may also store content associated with the mapping platform 107, the vehicle, the geographic database 115, the services platform 121, and/or the services 123. In another embodiment, the content providers 125 may manage access to a central repository of data, and offer a consistent, standard interface to data, such as a repository of the geographic database 115.

In one embodiment, as mentioned above, a UE 105 and/or a vehicle may be part of a probe-based system for collecting probe data for computing routes for all available transport modes and/or user historical routes. In one embodiment, each UE 105 and/or vehicle is configured to report probe data as probe points, which are individual data records collected at a point in time that records telemetry data for that point in time. In one embodiment, the probe ID can be permanent or valid for a certain period of time. In one embodiment, the probe ID is cycled, particularly for consumer-sourced data, to protect the privacy of the source.

In one embodiment, as previously stated, the vehicle is configured with various sensors (e.g., vehicle sensors) for generating or collecting probe data, sensor data, related geographic/map data (e.g., routing data), etc. In one embodiment, the sensed data represents sensor data associated with a geographic location or coordinates at which the sensor data was collected (e.g., a latitude and longitude pair). In one embodiment, the probe data (e.g., stored in or accessible via the geographic database 115) includes location probes collected by one or more vehicle sensors. By way of example, the vehicle sensors may include a RADAR system, a LiDAR system, global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data, an audio recorder for gathering audio data, velocity sensors mounted on a steering wheel of the vehicles, switch sensors for determining whether one or more vehicle switches are engaged, and the like. Though depicted as automobiles, it is contemplated the vehicles can be any type of private or shared manned or unmanned vehicle (e.g., cars, trucks, buses, vans, motorcycles, scooters, bicycles, drones, etc.) that travels through on road/off-road segments of a road network.

Other examples of sensors of the vehicle may include light sensors, orientation sensors augmented with height sensors and acceleration sensor (e.g., an accelerometer can measure acceleration and can be used to determine orientation of the vehicle), tilt sensors to detect the degree of incline or decline of the vehicle along a path of travel, moisture sensors, pressure sensors, etc. In a further example embodiment, vehicle sensors about the perimeter of the vehicle may detect the relative distance of the vehicle from a physical divider, a lane line of a link or roadway, the presence of other vehicles, pedestrians, traffic lights, potholes and any other objects, or a combination thereof. In one scenario, the vehicle sensors may detect weather data, traffic information, or a combination thereof. In one embodiment, the vehicle may include GPS or other satellite-based receivers to obtain geographic coordinates from satellites for determining current location and time. Further, the location can be determined by visual odometry, triangulation systems such as A-GPS, Cell of Origin, or other location extrapolation technologies.

In one embodiment, the UE 105 may also be configured with various sensors (e.g., device sensors 111) for acquiring and/or generating probe data and/or sensor data associated with a user, a vehicle (e.g., a driver or a passenger), other vehicles, conditions regarding the driving environment or roadway, etc. For example, such sensors 111 may be used as GPS receivers for interacting with the one or more satellites to determine and track the current speed, position and location of a user or a vehicle travelling along a link or on road/off road segment. In addition, the sensors 111 may gather tilt data (e.g., a degree of incline or decline of a vehicle during travel), motion data, light data, sound data, image data, weather data, temporal data and other data associated with the vehicle and/or UE 105. Still further, the sensors 111 may detect local or transient network and/or wireless signals, such as those transmitted by nearby devices during navigation along a roadway (Li-Fi, near field communication (NFC)) etc.

It is noted therefore that the above described data may be transmitted via the communication network 109 as probe data (e.g., GPS probe data) according to any known wireless communication protocols. For example, each UE 105, user, and/or the vehicle may be assigned a unique probe identifier (probe ID) for use in reporting or transmitting said probe data collected by the vehicles and/or UE 105. In one embodiment, each vehicle and/or UE 105 is configured to report probe data as probe points, which are individual data records collected at a point in time that records telemetry data.

In one embodiment, the mapping platform 107 retrieves aggregated probe points gathered and/or generated by the device sensors 111 and/or vehicle sensors resulting from the travel of the UE 105 and/or vehicles on a road segment of a road network or an off segment of a digital map. In one instance, the geographic database 115 stores a plurality of probe points and/or trajectories generated by different UEs 105, device sensors 111, vehicles, vehicle sensors, etc. over a period while traveling in a large monitored area (e.g., on road and/or off road). A time sequence of probe points specifies a trajectory—i.e., a path traversed by a UE 105, a vehicle, etc. over the period.

In one embodiment, the communication network 109 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the mapping platform 107 may be a platform with multiple interconnected components. The mapping platform 107 may include multiple servers, intelligent networking devices, computing devices, components, and corresponding software for providing parametric representations of lane lines. In addition, it is noted that the mapping platform 107 may be a separate entity of the system 100, a part of the services platform 121, a part of the one or more services 123, or included within a vehicle (e.g., an embedded navigation system).

In one embodiment, the geographic database 115 can store information regarding a user's mobility history or travels (e.g., a mobility graph), historical mobility patterns, route ranking factors and attributes, corresponding information and data, weights and/or weighting schemes, virtually marked features and attributes, user account information, user preferences, POI data (e.g., location data), etc. The information may be any of multiple types of information that can provide means for providing tailored multi-modal navigation assistance via virtual markers. In another embodiment, the geographic database 115 may be in a cloud and/or in a UE 105, a vehicle, or a combination thereof.

By way of example, the UE 105, mapping platform 107, device sensors 111, the applications (including VR/AR application 113), the vehicle, vehicle sensors, satellites, services platform 121, services 123, and/or content providers 125 communicate with each other and other components of the system 100 using well known, new or still developing protocols. In this context, a protocol includes a set of rules defining how the network nodes within the communication network 109 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

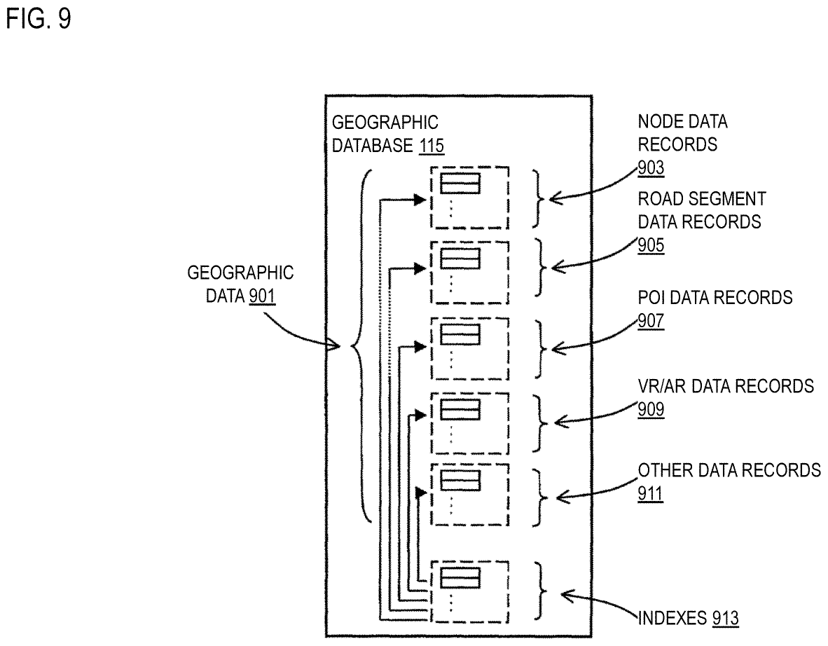

FIG. 9 is a diagram of a geographic database (such as the database 115), according to one embodiment. In one embodiment, the geographic database 115 includes geographic data 901 used for (or configured to be compiled to be used for) mapping and/or navigation-related services, such as for video odometry based on the parametric representation of lanes include, e.g., encoding and/or decoding parametric representations into lane lines. In one embodiment, the geographic database 115 include high resolution or high definition (HD) mapping data that provide centimeter-level or better accuracy of map features. For example, the geographic database 115 can be based on Light Detection and Ranging (LiDAR) or equivalent technology to collect billions of 3D points and model road surfaces and other map features down to the number lanes and their widths. In one embodiment, the HD mapping data (e.g., HD data records 911) capture and store details such as the slope and curvature of the road, lane markings, roadside objects such as signposts, including what the signage denotes. By way of example, the HD mapping data enable highly automated vehicles to precisely localize themselves on the road.

In one embodiment, geographic features (e.g., two-dimensional, or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 115.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 115 follows certain conventions. For example, links do not cross themselves and do not cross each other except at a node. Also, there are no duplicated shape points, nodes, or links. Two links that connect each other have a common node. In the geographic database 115, overlapping geographic features are represented by overlapping polygons. When polygons overlap, the boundary of one polygon crosses the boundary of the other polygon. In the geographic database 115, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 115 includes node data records 903, road segment or link data records 905, POI data records 907, VR/AR data records 909, HD mapping data records 911, and indexes 913, for example. More, fewer, or different data records can be provided. In one embodiment, additional data records (not shown) can include cartographic (“carto”) data records, routing data, and maneuver data. In one embodiment, the indexes 913 may improve the speed of data retrieval operations in the geographic database 115. In one embodiment, the indexes 913 may be used to quickly locate data without having to search every row in the geographic database 115 every time it is accessed. For example, in one embodiment, the indexes 913 can be a spatial index of the polygon points associated with stored feature polygons.

In exemplary embodiments, the road segment data records 905 are links or segments representing roads, streets, or paths, as can be used in the calculated route or recorded route information for determination of one or more tailored routes. The node data records 903 are end points corresponding to the respective links or segments of the road segment data records 905. The road link data records 905 and the node data records 903 represent a road network, such as used by vehicles, cars, and/or other entities. Alternatively, the geographic database 115 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 115 can include data about the POIs and their respective locations in the POI data records 907. The geographic database 115 can also include data about places, such as cities, towns, or other communities, and other geographic features, such as bodies of water, mountain ranges, etc. Such place or feature data can be part of the POI data records 907 or can be associated with POIs or POI data records 907 (such as a data point used for displaying or representing a position of a city).

In one embodiment, the geographic database 115 can also include VR/AR data records 909 for storing virtual marker data, VR/AR data, training data, prediction models, annotated observations, computed featured distributions, sampling probabilities, and/or any other data generated or used by the system 100 according to the various embodiments described herein. By way of example, the VR/AR data records 909 can be associated with one or more of the node records 903, road segment records 905, and/or POI data records 907 to support localization or visual odometry based on the features stored therein and the corresponding estimated quality of the features. In this way, the records 909 can also be associated with or used to classify the characteristics or metadata of the corresponding records 903, 905, and/or 907.

In one embodiment, as discussed above, the HD mapping data records 911 model road surfaces and other map features to centimeter-level or better accuracy. The HD mapping data records 911 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the HD mapping data records 911 are divided into spatial partitions of varying sizes to provide HD mapping data to vehicles and other end user devices with near real-time speed without overloading the available resources of the vehicles and/or devices (e.g., computational, memory, bandwidth, etc. resources).

In one embodiment, the HD mapping data records 911 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 911.

In one embodiment, the HD mapping data records 911 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 115 can be maintained by the content providers 125 in association with the services platform 121 (e.g., a map developer). The map developer can collect geographic data to generate and enhance the geographic database 115. There can be different ways used by the map developer to collect data. These ways can include obtaining data from other sources, such as municipalities or respective geographic authorities. In addition, the map developer can employ field personnel to travel by vehicle (e.g., vehicles and/or user terminals 105) along roads throughout the geographic region to observe features and/or record information about them, for example. Also, remote sensing, such as aerial or satellite photography, can be used.

The geographic database 115 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle or a user terminal 105, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing tailored multi-modal navigation assistance via virtual markers that transition between VR and AR may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

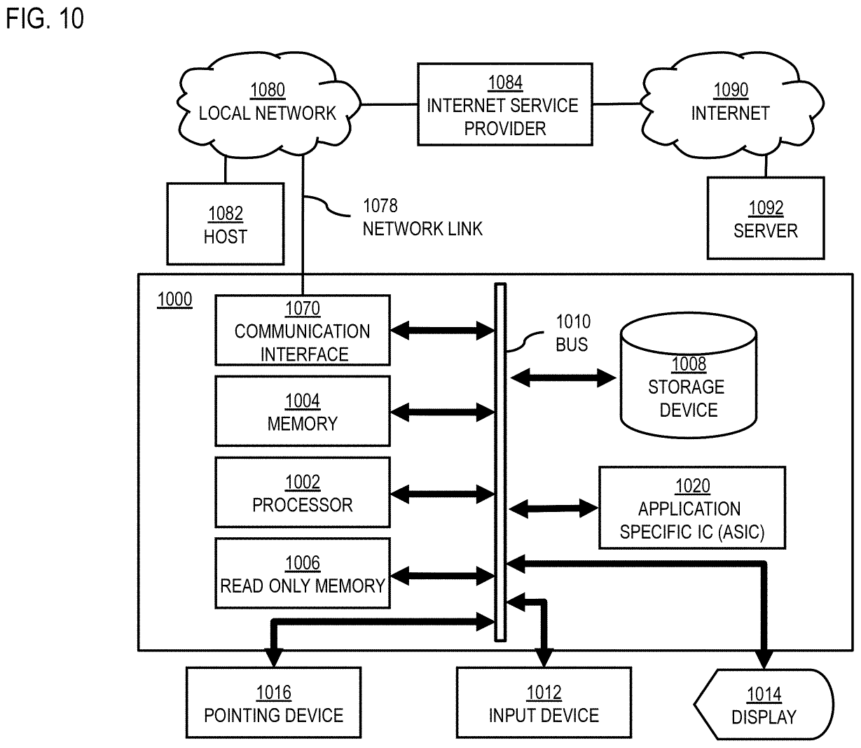

FIG. 10 illustrates a computer system 1000 upon which an embodiment of the invention may be implemented. Computer system 1000 is programmed (e.g., via computer program code or instructions) to provide tailored multi-modal navigation assistance via virtual markers that transition between VR and AR as described herein and includes a communication mechanism such as a bus 1010 for passing information between other internal and external components of the computer system 1000. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1010 includes one or more parallel conductors of information so that information is transferred quickly among devices coupled to the bus 1010. One or more processors 1002 for processing information are coupled with the bus 1010.

A processor 1002 performs a set of operations on information as specified by computer program code related to providing tailored multi-modal navigation assistance via virtual markers that transition between VR and AR. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1010 and placing information on the bus 1010. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1002, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1000 also includes a memory 1004 coupled to bus 1010. The memory 1004, such as a random access memory (RAM) or other dynamic storage device, stores information including processor instructions for providing tailored multi-modal navigation assistance via virtual markers that transition between VR and AR. Dynamic memory allows information stored therein to be changed by the computer system 1000. RAM allows a unit of information stored at a location called a memory address to be stored and retrieved independently of information at neighboring addresses. The memory 1004 is also used by the processor 1002 to store temporary values during execution of processor instructions. The computer system 1000 also includes a read only memory (ROM) 1006 or other static storage device coupled to the bus 1010 for storing static information, including instructions, that is not changed by the computer system 1000. Some memory is composed of volatile storage that loses the information stored thereon when power is lost. Also coupled to bus 1010 is a non-volatile (persistent) storage device 1008, such as a magnetic disk, optical disk, or flash card, for storing information, including instructions, that persists even when the computer system 1000 is turned off or otherwise loses power.

Information, including instructions for providing tailored multi-modal navigation assistance via virtual markers that transition between VR and AR, is provided to the bus 1010 for use by the processor from an external input device 1012, such as a keyboard containing alphanumeric keys operated by a human user, or a sensor. A sensor detects conditions in its vicinity and transforms those detections into physical expression compatible with the measurable phenomenon used to represent information in computer system 1000. Other external devices coupled to bus 1010, used primarily for interacting with humans, include a display device 1014, such as a cathode ray tube (CRT) or a liquid crystal display (LCD), or plasma screen or printer for presenting text or images, and a pointing device 1016, such as a mouse or a trackball or cursor direction keys, or motion sensor, for controlling a position of a small cursor image presented on the display 1014 and issuing commands associated with graphical elements presented on the display 1014. In some embodiments, for example, in embodiments in which the computer system 1000 performs all functions automatically without human input, one or more of external input device 1012, display device 1014 and pointing device 1016 is omitted.

In the illustrated embodiment, special purpose hardware, such as an application specific integrated circuit (ASIC) 1020, is coupled to bus 1010. The special purpose hardware is configured to perform operations not performed by processor 1002 quickly enough for special purposes. Examples of application specific ICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1000 also includes one or more instances of a communications interface 1070 coupled to bus 1010. Communication interface 1070 provides a one-way or two-way communication coupling to a variety of external devices that operate with their own processors, such as printers, scanners, and external disks. In general the coupling is with a network link 1078 that is connected to a local network 1080 to which a variety of external devices with their own processors are connected. For example, communication interface 1070 may be a parallel port or a serial port or a universal serial bus (USB) port on a personal computer. In some embodiments, communications interface 1070 is an integrated services digital network (ISDN) card or a digital subscriber line (DSL) card or a telephone modem that provides an information communication connection to a corresponding type of telephone line. In some embodiments, a communication interface 1070 is a cable modem that converts signals on bus 1010 into signals for a communication connection over a coaxial cable or into optical signals for a communication connection over a fiber optic cable. As another example, communications interface 1070 may be a local area network (LAN) card to provide a data communication connection to a compatible LAN, such as Ethernet. Wireless links may also be implemented. For wireless links, the communications interface 1070 sends or receives or both sends and receives electrical, acoustic, or electromagnetic signals, including infrared and optical signals, that carry information streams, such as digital data. For example, in wireless handheld devices, such as mobile telephones like cell phones, the communications interface 1070 includes a radio band electromagnetic transmitter and receiver called a radio transceiver. In certain embodiments, the communications interface 1070 enables connection to the communication network 105 for providing tailored multi-modal navigation assistance via virtual markers that transition between VR and AR to the UE 101.

The term computer-readable medium is used herein to refer to any medium that participates in providing information to processor 1002, including instructions for execution. Such a medium may take many forms, including, but not limited to, non-volatile media, volatile media, and transmission media. Non-volatile media include, for example, optical or magnetic disks, such as storage device 1008. Volatile media include, for example, dynamic memory 1004.

Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 1078 typically provides information communication using transmission media through one or more networks to other devices that use or process the information. For example, network link 1078 may provide a connection through local network 1080 to a host computer 1082 or to equipment 1084 operated by an Internet Service Provider (ISP). ISP equipment 1084 in turn provides data communication services through the public, world-wide packet-switching communication network of networks now commonly referred to as the Internet 1090.

A computer called a server host 1092 connected to the Internet hosts a process that provides a service in response to information received over the Internet. For example, server host 1092 hosts a process that provides information representing video data for presentation at display 1014. It is contemplated that the components of system can be deployed in various configurations within other computer systems, e.g., host 1082 and server 1092.

FIG. 11 illustrates a chip set 1100 upon which an embodiment of the invention may be implemented. Chip set 1100 is programmed to provide tailored multi-modal navigation assistance via virtual markers that transition between VR and AR as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to provide tailored multi-modal navigation assistance via virtual markers that transition between VR and AR. The memory 1105 also stores the data associated with or generated by the execution of the inventive steps.

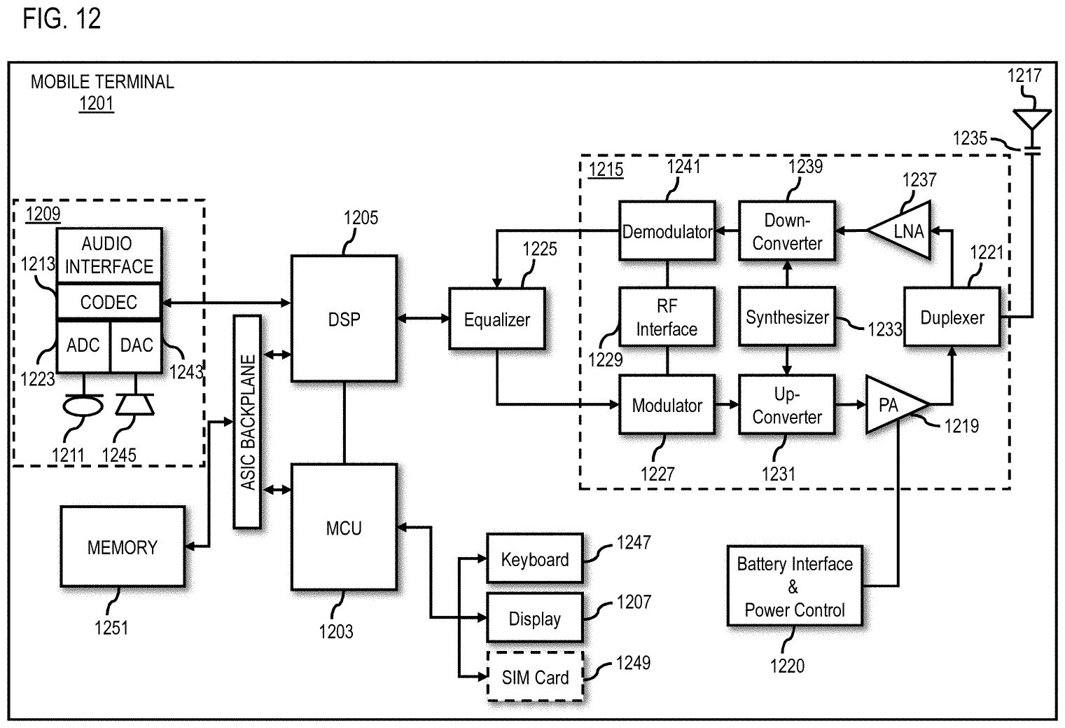

FIG. 12 is a diagram of exemplary components of a mobile terminal (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile station functions that offer automatic contact matching. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system, via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile station 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203—which can be implemented as a Central Processing Unit (CPU) (not shown).

The MCU 1203 receives various signals including input signals from the keyboard 1247. The keyboard 1247 and/or the MCU 1203 in combination with other user input components (e.g., the microphone 1211) comprise a user interface circuitry for managing user input. The MCU 1203 runs a user interface software to facilitate user control of at least some functions of the mobile station 1201 to provide tailored multi-modal navigation assistance via virtual markers that transition between VR and AR. The MCU 1203 also delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the station. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile station 1201.

The CODEC 1213 includes the ADC 1223 and DAC 1243. The memory 1251 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1251 may be, but not limited to, a single memory, CD, DVD, ROM, RAM, EEPROM, optical storage, or any other non-volatile or non-transitory storage medium capable of storing digital data.

An optionally incorporated SIM card 1249 carries, for instance, important information, such as the cellular phone number, the carrier supplying service, subscription details, and security information. The SIM card 1249 serves primarily to identify the mobile station 1201 on a radio network. The card 1249 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
computing a virtual reality world including a representation of a geographic location; and
generating one or more virtual markers in the virtual reality world for familiarizing with the representation of the geographic location,
wherein the one or more virtual markers are further presented in an augmented reality user interface based on detecting a physical journey to the geographic location.

2. The method of claim 1, further comprising:
computing a multi-modal route comprising at least two modes of transport,
wherein the geographic location is associated with the multi-modal route.

3. The method of claim 1, further comprising:
processing historical mobility data to determine one or more unfamiliar locations,
wherein the geographic location is selected from the one or more unfamiliar locations.

4. The method of claim 3, wherein the one or more unfamiliar locations are determined based on a number of visits indicated in the historical mobility data.

5. The method of claim 3, further comprising:
processing the historical mobility data to determine respective unfamiliarity scores for the one or more unfamiliar locations,
wherein the geographic location is selected based on the respective unfamiliarity scores.

6. The method of claim 1, wherein the one or more virtual markers are generated to indicate, to remind of, or a combination thereof an experience in the in the virtual reality world when presented in the augmented reality user interface.

7. The method of claim 1, wherein the geographic location is a connection location of a multi-modal journey.

8. The method of claim 7, wherein the virtual reality world simulates a transition at the connection location between a first transport mode and a second transport mode of the multi-modal journey.

9. The method of claim 1, wherein the virtual reality world is computed to simulate a designated context at the geographic location.

10. The method of claim 1, wherein the virtual reality world is computed to simulate a designated time constraint at the geographic location, and wherein the designated time constraint is based on a time availability for experiencing the virtual reality world, a connection time between legs of a multi-modal journey, or a combination thereof.

11. An apparatus comprising:
at least one processor; and
at least one memory including computer program code for one or more programs,
the at least one memory and the computer program code configured to, with the at least one processor, cause the apparatus to perform at least the following,
determine a physical presence at a geographic location;
retrieve one or more virtual markers associated with the geographic location, wherein the one or more virtual markers indicate a prior experience with a representation of the geographic location in a virtual reality world; and
present the one or more virtual markers in an augmented reality user interface during the physical presence at the geographic location.

12. The apparatus of claim 11, wherein the one or more virtual markers include an indication of a correct action, an incorrection action, or a combination thereof taken in the virtual reality world to simulate travel at the geographic location.

13. The apparatus of claim 12, wherein the travel at the geographic location is via a multi-modal route, and the one or more markers is associated with a transition between a first mode of transport and a second mode of transport of the multi-modal route.

14. The apparatus of claim 11, wherein the virtual reality world is computed based on determining that the geographic location is an unfamiliar location.

15. The apparatus of claim 14, wherein the unfamiliar location is determined based on a number of visits indicated in historical mobility data.

16. A non-transitory computer-readable storage medium carrying one or more sequences of one or more instructions which, when executed by one or more processors, cause an apparatus to perform:
determining a physical presence at a geographic location;
computing an augmented reality user interface overlaid on imagery of the geographic location; and
generating one or more virtual markers in the augmented reality user interface for familiarizing with travel at the geographic location,
wherein the one or more virtual markers are further presented in a virtual reality world computed to represent the geographic location.

17. The computer-readable storage medium of claim 16, wherein the travel at the geographic location is via a multi-modal route.

18. The computer-readable storage medium of claim 16, wherein the one or more markers is associated with a transition between a first mode of transport and a second mode of transport of the multi-modal route.

19. The computer-readable storage medium of claim 16, wherein the one or more virtual markers include an indication of a correct action, an incorrection action, or a combination thereof taken during the travel at the geographic location.

20. The computer-readable storage medium of claim 16, wherein the geographic location is determined based on respective unfamiliarity scores associated with one or more candidate unfamiliar locations.
